(19) United States
(12) Patent Application Publication
(10) Pub. No.: US 2020/0235844 A1
(43) Pub. Date: Jul. 23, 2020

(54) SYSTEMS AND METHODS FOR DISABLING AN UNMANNED AERIAL VEHICLE

(71) Applicant: STEALTH AIR CORP, Bohemia, NY (US)

(72) Inventor: Nicholas ADDONISIO, Eastport, NY (US)

(21) Appl. No.: 16/487,911

(22) PCT Filed: Feb. 27, 2018
(86) PCT No.: PCT/US2018/019919

§ 371 Date: Aug. 22, 2019

Related U.S. Application Data
(60) Provisional application No. 62/463,906, filed on Feb. 27, 2017.

(51) Int. Cl. H04K 3/00; B60L 58/12; B64C 39/02

(52) U.S. Cl. CPC H04K 3/92; H04K 3/90; B64C 2201/042; B64C 39/024; B60L 58/12

(57) ABSTRACT

Disclosed are systems and methods for disabling a battery in an un-manned aerial vehicle. The system includes a battery containing lithium; a battery disable unit; and a processor configured to: receive a disable command; and transmit the disable command to the battery disable unit to activate the battery disable unit to cause the battery to malfunction.

### REFERENCE TO PRIOR APPLICATIONS)

This application claims the benefit of U.S. Provisional Application No. 62/463,906, filed Feb. 27, 2017, the entire contents of which are incorporated herein by reference.

### TECHNICAL FIELD

The present invention relates to unmanned aerial vehicles, and more particularly to an unmanned aerial vehicle that is configured to be remotely disabled.

### BACKGROUND

Unmanned Aerial Vehicles (“UAVs”) are powered by various power sources. Due to the re-usable nature and accessibility of batteries, UAVs, or drones, are powered by re-chargeable battery packs. Batteries on UAVs are considered part of the “all-up-weight” of an aircraft and are considered when calculating and observing performance metrics of such aircraft. Aircraft are sensitive to weight as it affects the overall utility, performance and efficiency of the vehicle. Given their favorable weight to capacity characteristics, lithium-based batteries, more specifically lithium-polymer (“LiPO”), are used for recreational and commercial electric UAVs.

Under certain circumstances, a party may desire to equip a UAV to disable itself, and even self-destruct. In some instances, a UAV is equipped with an explosive material, for example a plastic explosive, and circuitry to detonate the incendive material, thus disabling or destroying the UAV. In addition, the explosion, or incendive event, itself can be used as a destructive or disruptive force in the surrounding environment of the UAV.

UAVs have a maximum capacity payload rating. Accommodating the equipment needed during the planned operation of the UAV, for example, cameras, shipment packages, etc., is always a concern for UAV designers and operators. One major problem with prior art systems that include self-destruct capabilities is the sacrifice of payload capacity needed to carry the explosive material.

The present invention solves these and other problems in the prior art.

SUMMARY

Disclosed is a vehicle, such as a UAV, that includes a system to intentionally disable the vehicle.

In one embodiment, a system for disabling a battery comprises a battery containing lithium; a battery disable unit connected to the battery; and a processor configured to: receive a disable command; and transmit the disable command to the battery disable unit to activate the battery disable unit to cause the battery to malfunction.

In another embodiment, a system for disabling a battery, comprises a lithium battery; memory; a disable unit; and a processor in communication with the memory, wherein the processor is configured to: receive a command to detonate a vehicle; and transmit a signal to the disable unit to detonate the vehicle, wherein the signal causes the lithium battery within the vehicle to malfunction.

In a further embodiment, a method for disabling a battery, comprises the steps of; receiving by a processor a disable command; transmitting by a processor the disable command; receiving by a disable unit the disable command; and implementing by the disable unit the disable command to disable the battery.

### BRIEF DESCRIPTION OF THE DRAWINGS

The present disclosure will become more readily apparent from the specific description accompanied by the drawings.

FIG. 1 is a diagram illustrating a system for disabling an unmanned aerial vehicle in accordance with aspects of the present disclosure.

FIG. 2 is a diagram illustrating a puncturing unit in a system for disabling an unmanned aerial vehicle in accordance with aspects of the present disclosure.

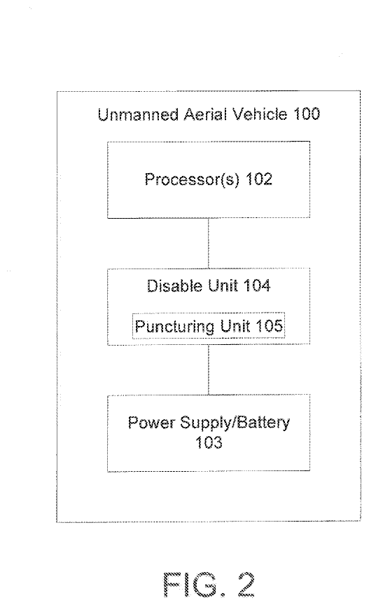

FIG. 3 is a diagram illustrating a short-circuiting unit in a system for disabling an unmanned aerial vehicle in accordance with aspects of the present disclosure.

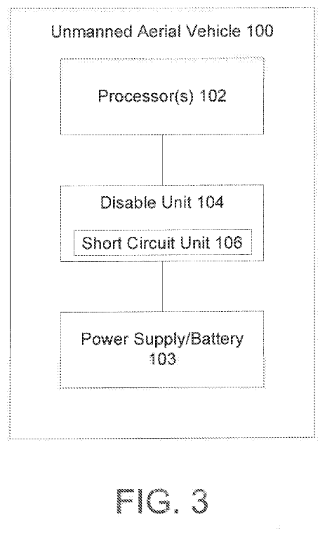

FIG. 4 is a diagram illustrating a chemical reaction unit in a system for disabling an unmanned aerial vehicle in accordance with aspects of the present disclosure.

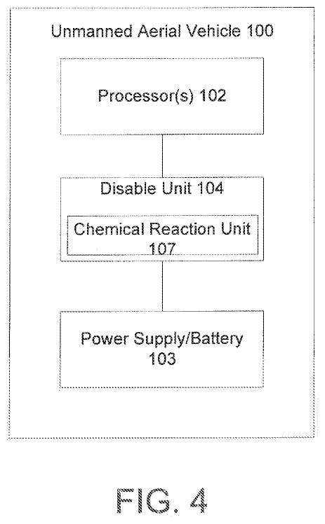

FIG. 5 is a method for disabling an unmanned aerial vehicle in accordance with aspects of the present disclosure.

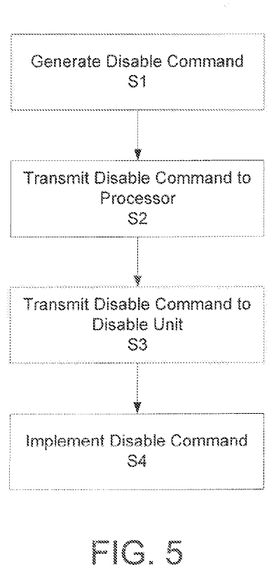

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

Lithium polymer batteries are available in several common form factors, voltages, capacities and number of cells. Regardless of the type of lithium polymer battery used for a specific application, LiPO batteries must be treated with care due to their volatile nature. The Federal Aviation Administration (“FAA”) recognizes the volatility of such batteries and even limits the power output and size of lithium batteries that an individual may carry on a passenger aircraft. In fact, package couriers recognize and abide by International Air Transport Association (IATA) guidelines and are aware of volatility of the Lithium-based batteries and are mandated to transport packages containing lithium batteries to follow government set protocols. Lithium batteries are considered “HAZMAT” material and generally need to accompany “Dangerous Goods” protocols when being transported due to the nature and difficulty of extinguishing the fire that they can cause if ignited, punctured, short-circuited, or crushed. Specifically, the FAA has stated that damage to a lithium-based battery if transported on a commercial aircraft could cause “catastrophic hull loss.”

Lithium based batteries, such as Lithium-Polymer (“LiPO”) batteries, are currently the battery chemistry of choice for electric power and propulsion systems for UAVs. While LiPO batteries are currently an efficient power source due to their weight to capacity ratio, they are volatile in the sense that instability including uneven cell voltages, punctures, or short circuits can cause a fire that is challenging or impossible to extinguish when using certain types of fire extinguishers.

Typically, UAVs include autopilots (i.e., flight controllers), or guidance computers, capable of performing advanced tasks. Some examples of advanced, non-flight related tasks include retracting landing gear, turning on lights, or deploying a parachute. Generally, the autopilot or an onboard companion or processing computer can handle such non-flight related tasks. In a situation where a UAV has collected sensitive data or has become compromised by an unintended capturer, the pilot, such as via radio frequency, cellular or satellite telemetry commands, or the autopilot can autonomously trigger an auxiliary command including an action to self-detonate, or produce an incendiary event, its own lithium battery power source. In this regard, if the autopilot mode is switched on or otherwise implemented, then a transceiver may not be necessary since the UAV is able to operate autonomously without any instructions or directions via Wifi, satellite, etc. Thus, the UAV is able to travel autonomously and then trigger self-detonation autonomously as well and this may occur when any one or more thresholds or actions are observed such as a geofence breach, a timed event, a land detected, geo-coordinate location reached, or any threshold of Inertial Measurement Unit (IMU) data observed including g-sensor force, which could imply a crash landing, or pitch or bank angle has been exceeded, possibly implying erratic flight behavior.

A vehicle, such as a UAV, that includes a system and method to intentionally disable the vehicle is disclosed herein.

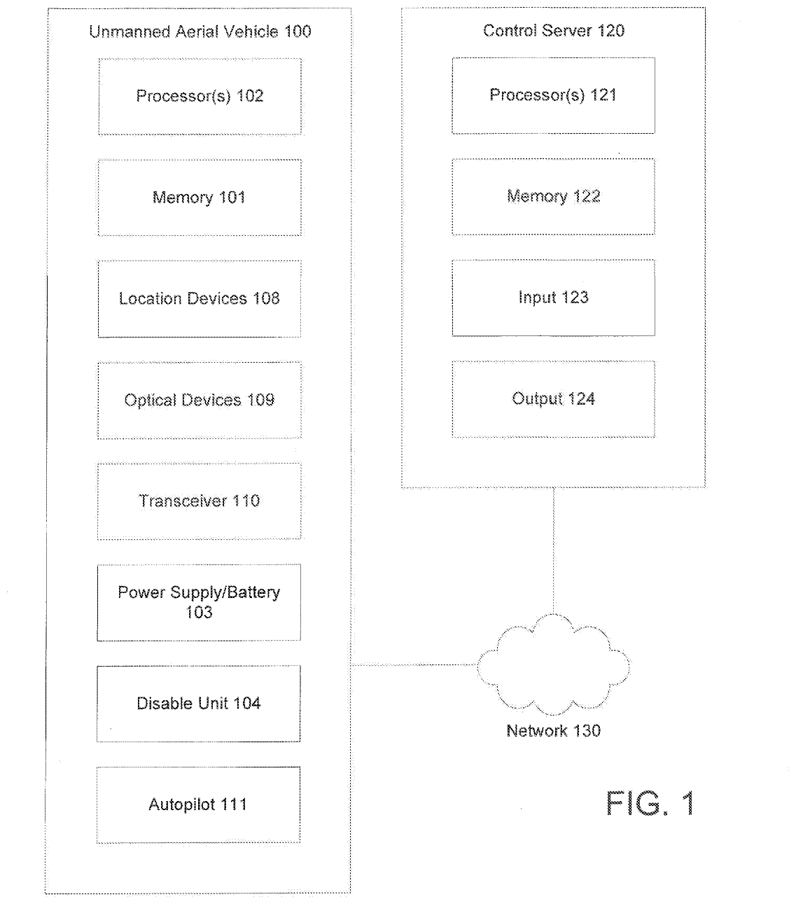

As shown in FIG. 1, a UAV 100 may include memory 101 for storing instructions and data, and one or more processors 102 in communication with the memory. The one or more processors 102 are configured to receive a command to detonate or damage a lithium polymer power supply 103 of the UAV 100. The processor 102 may transmit a signal to that causes the power supply 103 within the UAV 100 to detonate. Typically included in the UAV 100 are location device(s) 108, optical device(s) 109, transceiver(s) 110, and autopilot 111. Location device(s) 108 can include a Global Positioning System (GPS), a Global Navigation Satellite System (GNSS), a Real Time Kinematics (RTK); other location devices are contemplated. The optical device(s) 109 can include a visual spectrum camera, an infrared camera, thermal imaging devices, etc.; other optical devices are contemplated.

The transceiver(s) 110 are designed to communicate with a remote-control server 120 through a network 130. The type of communications performed over the network 130 can include one or more wireless networks, including, Radio Frequency (RF), cellular, Wifi, Bluetooth, satellite, etc.; other networks are contemplated.

The remote-control server 120 can include one or more processors 121, memory 122 for storing data and instructions, input/output devices 123, and a display 124. The remote-control server 120 permits remote control of the UVA by a pilot. The disable command would typically originate as a user input at the remote-control server 120. Although this is described as a preferred embodiment, the disable command can originate at the UAV itself based on preset conditions having been met. For example, a UAV on a secret mission that experiences a sudden and extreme drop in altitude detected could generate the disable command and destroy the UAV. In another embodiment, the UAV can be equipped with sensors to detect unauthorized tampering with the UAV and generate the disable command when an anti-tampering event occurs.

UAV 100 includes a disable unit 104. The disable unit 104 implements the actual disabling of the battery 103. There are various methods in which the disable unit 104 can cause the battery 103 to be intentionally disabled, detonated or damaged for the purpose of causing a difficult-to-extinguish fire and/or smoke event. Although many of the embodiments set forth herein deal with specific systems that result in the disabling of the battery 103, the general concept of battery disruption is a focus of the application.

In one embodiment, a disable signal transmitted to the disable unit 104 can control a puncture unit 105 to puncture the battery 103 to cause the battery 103 to detonate. The puncture unit 105 can include a spring-loaded awl, an on-board drill, an auger-like rotating screw, a small charged load (e.g., a bullet), etc.; other implementations of the puncture unit 105 are contemplated.

In another embodiment, the disable signal received by the disable unit 104 can control a short circuit unit 106 to operate a switching circuit to short circuit the terminals of the battery 103, which thereby causes the battery to detonate.

In yet another embodiment, the disable signal may cause the disable unit 104 to control the short circuit unit 106 to operate a switching circuit to insert a resistor between the terminals to depreciate the voltage and capacity of the battery, thereby causing the battery to become unstable and potentially explode or react in a manner that is self-destructive and/or highly volatile.

In still yet another embodiment, the disable signal received by the disable unit 104 can control a chemical reaction unit 107 to expose the lithium in the battery 103 to elements that cause the lithium to combust. One example of this type of chemical reaction can be to expose the lithium to water which will cause the lithium to combust

In still yet another embodiment, the disable signal received by the disable unit 104 can control a vice-like mechanical system comprising of motors, such as stepper motors, a threaded rod and one or more plates that surround the battery 103 can physically squeeze the battery 103 until it becomes volatile or an incendive event takes place.

Combinations of the above-mentioned, and other implementations of the disable unit, can also be implemented.

The actual implementation of the above-referenced disable unit 104 can include many different on-board apparatuses. The following are examples of disable unit 104 implementations.

Using a servo motor similar to those used for retractable UAV landing gear or other actuator style mechanism which has a puncturing attribute that resembles that of a needle, nail, or razor blade by penetrating the battery case which generally consists of plastic wrapper, thin metal or other light-weight materials. The purpose is to either break partitions within the battery and allowing anodes, cathodes and any other interior component to force them to make contact, or to expose these elements to air and/or moisture.

Using a servo, actuator, or spring-loaded mechanism may be responsible for making contact with an ammunition cartridge (bullet) whereby the projectile(s) enter and pierce the partitions of the battery and allow air to contact such exposed elements, or allows the internal components of the battery to make contact with each other.

Short-circuiting any positive and negative trace within the electrical system. A short-circuit may involve a servo or switching diode to connect the otherwise separate positive and negative lines within the electrical system.

Enabling a resistor within the circuit to depreciate the voltage and capacity of the battery to an unsafe level. Lithium polymer batteries specifically become swollen or “puffed” and can become particularly volatile when in this state. Furthermore, enabling a resistor to drain the battery at a rapid rate causes further instability due to the discharge rating exceeding the manufacturer's specified safe rate.

Introducing water into a cell or multiple cells within the battery by way of puncture with a servo motor and pin or a solenoid. Water and lithium can react in a way that is “explosive” and eruptive.

Initiate, or provide power to, a heating coil, thermal heat emitter (or emitters), or any other heating element which is/are mounted against the battery. The purpose is to generate a temperature greater than the battery exterior would otherwise be able to normally handle so that an exothermic reaction is caused and accelerated by way of the cell, which has been exposed to such high heat, combusts, sparks or reacts in a way that adjacent cells are also affected.

Penetrating mechanisms including compressed air or pneumatic tools, water jet cutter, augers, rotating drill bits, or screws may be used, but are most practical if the total weight of the mechanism is favorable respective of the weight and balance requirements of the aircraft.

There are a multitude of benefits that can be realized with an unmanned aerial vehicle with such self-destruction capabilities. Due to the probability of smoke and/or fire following intentional battery damage, a vehicle is more likely to be located in the event of a crash landing as both smoke and/or heat can provide a visual and/or thermal signature for the person, party or technology that is searching for that vehicle. Second, if used as a complement to military or law enforcement efforts, the vehicle might contain sensitive data, media, software, firmware, or novelty in hardware design such that self-destruction would impair an opposing party from retrieving the vehicle and identifying the owner or operating party of the vehicle, or prevent obtaining or operating the vehicle as it was intended to be originally used before the self-destruction event. Third, the smoke and/or fire event caused by such an event can attract and/or direct the attention of an opposing party or individual, causing their resources to be diverted from one activity to that of identifying and attempting to extinguish or control the UAV destruction event.

In a method for disabling a battery-operated vehicle, in step S1 a disable command is generated either by a user or automatically by a preset event. In step S2 the disable command is transmitted to the processor 102. In step S3 the processor 102 sends a disable command to the disable unit 104. In step S4 the disable unit 104 implements the disable command via one of the above-disclosed systems, thus causing the battery to become disabled and produce a detonation, fire, smoke as described above.

In any of the methods that are used, the intent is to create a lithium-based fire and/or smoke event for any of the reasons previously mentioned.

Due to the desirability to maintain efficient flight performance of the aircraft, relatively low-weight hardware such as the previously described mechanisms would be an efficient method in partial or whole destruction of the lithium power source payload of the UAV. By leveraging the inherent instability and volatility of the lithium power source, the intentional act of destruction of the UAV, UAV systems components, and possibly the surrounding environment, are practical with the use of the disclosed systems and methods.

Where this application has listed the steps of a method or procedure in a specific order, it may be possible, or even expedient in certain circumstances, to change the order in which some steps are performed, skip certain steps if quicker operation is programmed, and it is intended that the particular steps of the method or procedure claim set forth here below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A system for disabling a battery, comprising:
a battery containing lithium;
a battery disable unit connected to the battery; and
a processor configured to:
receive a disable command; and
transmit the disable command to the battery disable unit to activate the battery disable unit to cause the battery to malfunction.

2. The system of claim 1, wherein the battery disable unit comprises a switching unit connected between a positive terminal and a negative terminal of the lithium battery, and wherein upon receiving the disable command the battery disable unit activates the switching unit to short circuit the positive terminal to the negative terminal of the battery.

3. The system of claim 1, wherein the battery disable unit comprises a puncturing unit in proximity to the battery, and wherein upon receiving the disable command the battery disable unit activates a puncturing unit to puncture the battery thereby exposing the lithium to outside air.

4. The system of claim 1, wherein the battery disable unit comprises a chemical reaction unit, and wherein upon receiving the disable command the battery disable unit activates the chemical reaction unit to expose the lithium to a compound that causes the lithium to combust.

5. The system of claim 5, wherein the compound is water.

6. The system of claim 1, wherein the disable command is generated by a remote user.

7. The system of claim 1, wherein the disable command is generated based on preset parameters.

8. The system of claim 7, wherein the preset parameters include on or more of a decrease in altitude, a system fault, and a tampering event.

9. An unmanned aerial vehicle, comprising the system of claim 1.

10. A system for disabling a battery, comprising:
a lithium battery;
memory;
a disable unit; and
a processor in communication with the memory, wherein the processor is configured to:
receive a command to detonate a vehicle; and
transmit a signal to the disable unit to detonate the vehicle, wherein the signal causes the lithium battery within the vehicle to malfunction.

11. The system of claim 10, wherein the signal causes a component to puncture the battery to cause the battery to detonate.

12. The system of claim 11, wherein the signal further causes water to enter the puncture of the battery.

13. The system of claim 10, wherein the signal causes a short circuit to the battery, which thereby causes the battery to detonate.

14. The system of claim 10, wherein the signal causes a resistor to depreciate a voltage and capacity of the battery, thereby causing the battery to detonate.

15. The system of claim 10, wherein the battery is a lithium polymer battery.

16. An unmanned aerial vehicle, comprising the system of claim 10.

17. A method for disabling a battery, comprising the steps of:
receiving by a processor a disable command;
transmitting by a processor the disable command;
receiving by a disable unit the disable command; and
implementing by the disable unit the disable command to disable the battery.

18. The system of claim 17, wherein the disable command causes a component to puncture the battery to cause the battery to detonate.

19. The system of claim 17, wherein the disable command causes water to enter the battery.

20. The system of claim 17, wherein the disable command causes a short circuit to the battery, which thereby causes the battery to detonate.
